(19) United States
(12) Patent Application Publication
(10) Pub. No.: US 2021/0023756 A1
(43) Pub. Date: Jan. 28, 2021

(54) FILM, FILM MANUFACTURING METHOD, LAMINATED BODY, AND PACKAGING MATERIAL

(71) Applicant: AGC Inc., Tokyo (JP)

(72) Inventors: Yoshiaki Higuchi, Tokyo (JP); Shintaro Fukunaga, Tokyo (JP); Takatoshi Yaoita, Tokyo (JP)

(73) Assignee: AGC Inc., Tokyo (JP)

(21) Appl. No.: 17/070,990

(22) Filed: Oct. 15, 2020

Related U.S. Application Data
(63) Continuation of application No. PCT/JP2019/031974, filed on Aug. 14, 2019.

(30) Foreign Application Priority Data
Aug. 24, 2018 (JP) 2018-157182

(51) Int. Cl. B29C 48/08; B29C 48/00; B29C 48/92; B32B 27/30

(52) U.S. Cl. CPC B29C 48/08; B29C 48/022; B29C 48/92; B32B 27/304; B29K 2027/12; B29C 2948/92704; B29C 2948/92876; B29C 2948/92904; B29C 48/0017

(57) ABSTRACT

To provide a film made of polychlorotrifluoroethylene (PCTFE), of which a laminate with other layer is less likely to curl when subjected to drawing.

A film comprising PCTFE, having thermal shrinkage rates within ±1.2% in MD and in TD when heated at 140° C. for 30 minutes and then cooled to 25° C., based on the dimension at 25° C.

### TECHNICAL FIELD

The present invention relates to a film, a process for producing a film, a laminate, and a packaging material.

### BACKGROUND ART

A polychlorotrifluoroethylene (hereinafter sometimes referred to as “PCTFE”) film is used for e.g. packaging of pharmaceutical preparations by virtue of its excellent water vapor barrier property. For example, on a laminate having a layer consisting of a PCTFE film and other layer laminated, a pocket portion to accommodate a capsule or the like is provided by drawing to form a base material for blister packaging.

In recent years, as improvement of long term storage stability of pharmaceutical preparations and thickness reduction of films used are required, PCTFE films are required to have further improved water vapor barrier property.

As a method of improving the water vapor barrier property of the PCTFE films, the following methods have been proposed.
Molten PCTFE is extruded and cooled to a temperature of less than the melting point to form a crystalline PCTFE film, which is oriented under the predetermined conditions (Patent Document 1).
A process comprising a step of melting and forming PCTFE into a film, a step of holding the formed film at from 100 to 170° C., and a step of cooling the film after held to room temperature, wherein the temperature of the film is not lowered to 170° C. or below until the step of holding the formed film at from 100 to 170° C. (Patent Document 2).

### PRIOR ART DOCUMENTS

### Patent Documents

Patent Document 1: JP-A-2007-508962
Patent Document 2: JP-A-2015-98168

### DISCLOSURE OF INVENTION

### Technical Problem

However, a layer consisting of a film produced by the method in Patent Document 1 has a problem such that when laminated with other layer and the resulting laminate is subjected to drawing, the laminate is likely to curl. The film produced by the process in Patent Document 2 has the same problem.

The object of the present invention is to provide a PCTFE film, a laminate of which with other layer is less likely to curl when subjected to drawing, and a laminate and a packaging material using it.

Another object of the present invention is to provide a process for producing a PCTFE film having low thermal shrinkage rates.

### Solution to Problem

The present invention provides a film, a process for producing a film, a laminate and a packaging material, having the following constructions [1] to [12].

[1] A film comprising polychlorotrifluoroethylene,

having thermal shrinkage rates within ±1.2% in MD and in TD when heated at 140° C. for 30 minutes and then cooled to 25° C., based on the dimension at 25° C.

[2] The film according to [1], which has a haze per thickness 100 μm of from 3 to 20%.
[3] The film according to [1] or [2], which has a water vapor transmission rate of at most 0.07 g/(m²·day) per thickness 100 μm at 37.8° C. under a relative humidity of 100%.
[4] The film according to any one of [1] to [3], which has tensile elongations in MD and in TD at 23° C. of respectively at least 30%.
[5] A process for producing a film, which comprise melting a resin material containing polychlorotrifluoroethylene and extruding it into a film from an extrusion die, and bringing the extruded product into contact with at least one casting roll to form a film,
wherein before the extruded product is brought into contact with the at least one casting roll, the surface temperature of the extruded product is adjusted to be less than 170° C.
   [6] The process for producing a film according to [5], wherein before the extruded product is brought into contact with the at least one casting roll, air in a laminar follow is made to blow on the extruded product by an air knife.
   [7] The process for producing a film according to [5], wherein the distance from the outlet of the extrusion die to the contact point where the extruded product is brought into contact with the at least one casting roll for the first time, is from 80 to 1,000 mm.
   [8] The process for producing a film according to [6], wherein the distance from the outlet of the extrusion die to the contact point here the extruded product is brought into contact with the at least one casting roll for the first time, is from 80 to 500 mm.
   [9] The process for producing a film according to any one of [5] to [8], wherein the film forming rate is from 1 to 50 m/min.
   [10] A laminate comprising the film as defined in any one of [1] to [4], and at least one other layer.
   [11] A packaging material comprising the film as defined in any one of [1] to [4], or the laminate as defined in [10].
   [12] The packaging material according to [11], for blister packaging.

### Advantageous Effects of Invention

When the film of the present invention is laminated with other layer and the resulting laminate is subjected to drawing, the laminate is less likely to curl.

The laminate of the present invention is less likely to curl when subjected to drawing.

The packaging material of the present invention is less likely to curl when subjected to drawing.

According to the process for producing a film of the present invention, it is possible to produce a PCTFE film having low thermal shrinkage rates.

### BRIEF DESCRIPTION OF DRAWINGS

FIG. 1 is a view schematically illustrating an example of an apparatus for producing a film.

FIG. 2 is a cross sectional view schematically illustrating an example of a laminate of the present invention.

FIG. 3 is a cross sectional view schematically illustrating an example of blister packaging.

### DESCRIPTION OF EMBODIMENTS

Meanings of the following terms in this specification are as follows.

“MD” means a machine direction, and “TD” means a transverse direction at right angles to MD.

The “melting point” means a temperature corresponding to the maximum value of a melting peak of a polymer measured by differential scanning calorimetry (DSC).

The “crystallization temperature” is a temperature corresponding to the maximum value of an exothermic peak which appears when a molten polymer is cooled at a rate of 10° C./min, by DSC.

The “melt volume float rate” (MVR) of PCTFE is a value (mm³/sec) measured in accordance with the method specified in JIS K7210-1:2014 (corresponding international standard ISO 1133-1:2011), at 230° C. under a pressure of 100 kg/cm² using an orifice having a length of 1 mm and an inner diameter of 1 mm.

The “surface temperature of an extruded product” is a value obtained by radiation temperature measurement. Specifically, it is a temperature measured by an infrared radiation thermometer at an emissivity of 0.85 at an angle of 30° to the surface of an object to be measured at a position about 20 cm apart from the surface. In the present invention, the surface temperature of an extruded product is a measured value at the center in TD that is in the film width direction.

The “surface temperature of a casting roll” is a value measured by a contact type surface thermometer.

The “thermal shrinkage rate” is a value when an objected is heated at 140° C. for 30 minutes and then cooled to 25° C. based on the dimension at 25° C., and particularly, obtained by the method in the above-described Examples.

The “water vapor transmission rate per thickness 100 μm” is the water vapor transmission rate of the film when the film has a thickness of 100 μm. When the thickness of the film is not 100 μm, it is a value calculated in accordance with the following formula 1.

Water vapor transmission rate per 100 μm thickness=water vapor transmission rate of the film×(thickness of the film/100 μm)) formula 1

The “thickness” is a value measured by a contact type thickness meter.

The “water vapor transmission rate” (hereinafter sometimes referred to as “WVTR”) is a value measured in accordance with the method specified in JIS K7129:2008 Appendix B (infrared detection sensor method).

The “haze per thickness 100 μm” is the haze of film when the film has a thickness of 100 μm. When the thickness of the film is not 100 μm, it is a value calculated in accordance with the following formula 2.

Haze per thickness 100 μm=haze of the film×(100/thickness of the film (μm)) formula 2

The “haze” is a value measured in accordance with the method specified in JIS K7136:2000 (corresponding international standard: ISO 14782:1999) using CIE standard colorimetric illuminant D65 in accordance with JIS Z8781-2:2012 (corresponding international standard ISO 11664-2:2007) at 23° C.

The “tensile elongation” is a value measured in accordance with ASTM D638 with respect to an ASTM V dumbbell test specimen at a pulling rate of 200 mm/min at 23° C.

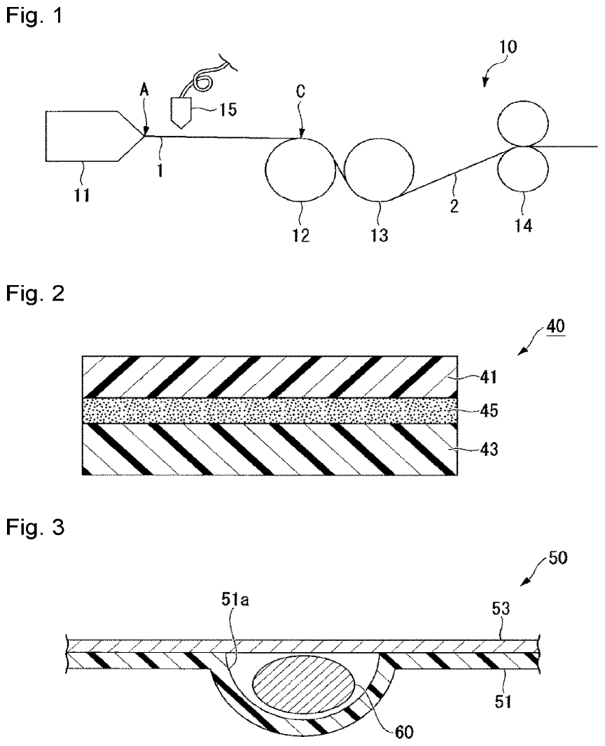

The dimensional ratios in FIGS. 1 to 3 are different from actual ones for the convenience of explanation.

### [Film]

The film of the present invention comprises PCTFE.

PCTFE in the present invention is a polymer containing units based on chlorotrifluoroethylene (hereinafter sometimes referred to as “CTFE”) (hereinafter sometimes referred to as “CTFE units”).

PCTFE may contain units based on a monomer copolymerizable with CTFE. PCTFE may contain one type or two or more types of units based on other monomer.

Other monomer may, for example, be a fluoromonomer other than CTFE or a monomer having no fluorine atom (hereinafter sometimes referred to as “non-fluorinated monomer”).

The fluoromonomer other than CTFE may, for example, be a fluoroolefin such as vinyl fluoride, vinylidene fluoride, trifluoroethylene, tetrafluoroethylene, hexafluoropropylene or hexafuoroisobutylene, a perfluoro(alkyl vinyl ether), fluorovinyl ether having a functional group, fluoro(divinyl ether), polyfluoro(alkyl ethylene) or a fluoromonomer having a cyclic structure.

The perfluoro(alkyl vinyl ether) may, for example, be CF₂═CFOCF₃, CF₂═CFOCF₂CF₃, CF₂═CFOCF₂CF₂CF₃, CF₂═CFOCF₂CF₂CF₂CF₃ or CF₂═CFO(CF₂)₆F.

The polyfluoro(alkyl ethylene) may, for example, be CH₂═CF(CF₂)₂F, CH₂═CF(CF₂)₃F, CH₂═CF(CF₂)₄F, CH₂═CF(CF₂)₅F, CH₂═CF(CF₂)₆F, CH₂═CF(CF₂)₂H, CH₂═CF(CF₂)₃H, CH₂═CF(CF₂)₄H, CH₂═CF(CF₂)₅H, CH₂═CF(CF₂)₆H, CH₂═CH(CF₂)₂F, CH₂═CH(CF₂)₃F, CH₂═CH(CF₂)₄F, CH₂═CH(CF₂)₅F, CH₂═CH(CF₂)₆F, CH₂═CH(CF₂)₂H, CH₂═CH(CF₂)₃H, CH₂═CH(CF₂)₄H, CH₂═CH(CF₂)₅H or CH₂═CH(CF₂)₆H.

The fluorovinyl ether having a functional group may, for example, be CF₂═CFOCF₂CF(CF₃)OCF₂CF₂SO₂F, CF₂═CFOCF₂CF₂SO₂F, CF₂═CFOCF₂CF(CF₃)OCF₂CF₂SO₃H, CF₂═CFOCF₂CF₂SO₃H, CF₂═CFO(CF₂)₃COOCH₃ or CF₂═CFO(CF₂)₃COOH.

The fluoro(divinyl ether) may, for example, be CF₂═CFCF₂CF₂OCF═CF₂, CF₂═CFCF₂OCF═CF₂, CF₂═CFO(CF₂)₃OCF═CF₂, CF₂═CFO(CF₂)₄OCF═CF₂ or CF₂═CFO(CF₂)₆OCF═CF₂.

The fluoromonomer having a cyclic structure may, for example, be perfluoro(2,2-dimethyl-1,3-dioxole), 2,2,4-trifluoro-5-trifluoromethoxy-1,3-dioxole or perfluoro(2-methylene-4-methyl-1,3-dioxolane).

The non-fluorinated monomer may, for example, be a monomer having at least one type of functional group selected from the group consisting of a carbonyl group-containing group, a hydroxy group, an epoxy group, an amide group, an amino group and an isocyanate group and containing no fluorine atom (hereinafter sometimes referred to as “functional monomer”), an olefin (such as ethylene) or a vinyl ester (such as vinyl acetate).

The functional group of the functional monomer is preferably a carbonyl group-containing group in view of adhesion at an interface with other layer. The carbonyl group-containing group may, for example, be a keto group, a carbonate group, a carboxy group, a haloformyl group, an alkoxycarbonyl group or an acid anhydride group.

The keto group is preferably contained between carbon atoms of a C₂₋₈ alkylene group. The number of carbon atoms of the alkylene group is the number of carbon groups not including carbon atoms of the keto group. The alkenylene group may be linear or branched.

The haloformyl group may, for example, be —C(═O)F, —C(═O)Cl, —C(═O)Br or —C(═O)I, and is preferably —C(═O)F.

The alkoxy group in the alkoxycarbonyl group is preferably a C₁₋₈ alkoxy group, particularly preferably a methoxy group or an ethoxy group.

The carbonyl group-containing group is preferably an acid anhydride group or a carboxy group.

The functional monomer is preferably a monomer having a carboxy group such as maleic acid, itaconic acid, citraconic acid or undecylenic acid, a monomer having an acid anhydride group such as itaconic anhydride (hereinafter sometimes referred to as “IAH”), citraconic anhydride (hereinafter sometimes referred to as “CAH”), 5-norbornene-2,3-dicarboxylic anhydride (hereinafter sometimes referred to as “NAH”) or maleic anhydride, a hydroxyalkyl vinyl ether or an epoxyalkyl vinyl ether, and is preferably a monomer having a carboxy group or a monomer having an acid anhydride group.

The monomer having an acid anhydride group is preferably IAH, CAH or NAH.

The functional monomer may be used alone or in combination of two or more.

PCTFE may have a functional group as the terminal group of the polymer main chain.

PCTFE having a functional group as the terminal group of the polymer main chain is obtained by polymerization using a chain transfer agent or a polymerization initiator which brings about the functional group.

The chain transfer agent which brings about the functional group may, for example, be acetic acid, acetic anhydride, methyl acetate, ethylene glycol or propylene glycol.

The polymerization initiator which brings about the functional group may, for example, be di-n-propyl peroxydicarbonate, diisopropyl peroxycarbonate, tert-butyl peroxyisopropylcarbonate, bis(4-tert-butylcyclohexyl) peroxydicarbonate or di-2-ethylhexyl peroxydicarbonate.

The proportion of the CTFE units to the total of all units constituting PCTFE is preferably from 90 to 100 mol %, more preferably from 95 to 100 mol %, particularly preferably from 97 to 100 mol %, most preferably 100 mol % (that is PCTFE is a CTFE homopolymer). When the proportion of the CTFE units is at least the above lower limit value, the resulting film will be more excellent in water vapor barrier property.

MVR of PCTFE is preferably from 1 to 400 mm³/sec, more preferably from 5 to 350 mm³/sec, particularly preferably from 10 to 300 mm³/sec. When MVR is at least the above lower limit value, excellent forming property will be obtained, and a film excellent in surface smoothness and outer appearance tends to be obtained. When MVR is at most the above upper limit value, a film excellent in mechanical strength is likely to be obtained.

The melting point of PCTFE is preferably from 200 to 225° C., particularly preferably from 205 to 220° C. When the melting point of PCTFE is at least the above lower limit value, the resulting film will be excellent in heat resistance. When the melting point of PCTFE is at most the above upper limit value, the film will easily be formed.

The film of the present invention may further contain, within a range not to impair the effects of the present invention, as the case requires, e.g. additives.

The additives may, for example, be a dye such as an organic pigment and an inorganic pigment, a heat stabilizer such as copper oxide, and an antistatic agent such as an ionic liquid.

The proportion of PCTFE to the total mass of the film of the present invention is preferably from 97 to 100 mass %, more preferably from 99 to 100 mass %, further preferably from 99.5 to 100 mass %, particularly preferably from 99.7 to 100 mass %. When the proportion of PCTFE is at least the above lower limit value, the resulting film will be more excellent in water vapor barrier properties.

The thickness of the film of the present invention is, for example, from 6 to 500 μm, and may be properly selected considering e.g. application of the film and the desired WVTR.

For example, in a case where a layer consisting of the film of the present invention is laminated with other layer to form a laminate, and the laminate is used for blister packaging, the thickness of the layer consisting of the film is preferably from 6 to 100 μm.

The thermal shrinkage rate of the film of the present invention in MD is within ±1.2%, preferably within ±1.0%, particularly preferably within ±0.8%.

The thermal shrinkage rate of the film of the present invention in TD is within ±1.2%, preferably within ±1.0%, particularly preferably within ±0.8%.

When the thermal shrinkage rates in MD and in TD are within the above ranges, when the film of the present invention is laminated with other layer and the resulting laminate is subjected to drawing, the laminate is less likely to curl.

The thermal shrinkage rates of the film in MD and in TD may be adjusted e.g. by film forming conditions, post-processing after forming, etc. For example, in the after-described process for producing a film of the present invention, the thermal shrinkage rates can be adjusted by the surface temperature of the extruded product when the extruded product is brought into contact with at least one casting roll for the first time.

If orientation treatment is conducted after forming, the thermal shrinkage rates tend to be high. The orientation treatment may be conducted so long as the thermal shrinkage rates are not out of the above ranges, however, it is preferred not to conduct the orientation treatment. Accordingly, the film of the present invention is preferably a non-oriented film.

The haze of the film of the present invention per thickness 100 μm is preferably from 3 to 20%, more preferably from 5 to 18%, particularly preferably from 7 to 16%.

The higher the haze is, the higher the degree of crystallization of the film tends to be. The higher the degree of crystallization of the film is, the higher the water vapor barrier property tends to be and the smaller the tensile elongations tend to be.

When the haze per thickness 100 μm is at least the above lower limit value, the film will be more excellent in water vapor barrier property. When the haze per thickness 100 μm is at most the above upper limit value, the film will be more excellent in tensile elongations and is easily drawn. Further, the film has favorable transparency.

WVTR of the film of the present invention per thickness 100 μm at 37.8° C. under a relative humidity of 100% is preferably at most 0.07 g/(m²·day), more preferably at most 0.06 g/(m²·day), particularly preferably at most 0.05 g/(m²·day). The lower the above WVTR, the more excellent the water vapor barrier property.

The above WVTR is preferably as low as possible in view of water vapor barrier property, however, if WVTR becomes low, the tensile elongations tend to be small. Accordingly, WVTR under a relative humidity of 100% is preferably at least 0.02 g/(m²·day), more preferably at least 0.03 g/(m²·day).

Further, in view of balance between the water vapor barrier property and the tensile elongations, WVTR is preferably from 0.02 to 0.07 g/(m²·day), particularly preferably from 0.03 to 0.06 g/(m²·day).

The tensile elongations of the film of the present invention in MD and in TD at 23° C. are respectively preferably at least 30%, more preferably at least 50%, particularly preferably at least 70%. When the tensile elongations are at least the above lower limit value, the film of the present invention and a laminate of the film of the present invention with other layer are less likely to be broken when subjected to drawing.

The upper limits of the tensile elongations of the film in MD and in TD at 23° C. are, for example, 350%.

The film of the present invention may be produced, for example, by the after-described process for producing a film of the present invention.

When the above-described film of the present invention, which has thermal shrinkage rates in MD and in TD within the above ranges, is laminated with other layer and the resulting laminate is subjected to drawing, the laminate is less likely to curl.

Further, the film of the present invention, which comprises PCTFE, is excellent in water vapor barrier property.

Heretofore, for blister packaging, a laminate having a PCTFE film laminated on a substrate film (such as a polyvinyl chloride film or polypropylene film) so as to impart water vapor barrier property, is subjected to drawing. At the time of drawing, heat at a level of from 80 to 160° C. is applied to the laminate. According to the studies by the present inventors, a conventional PCTFE film has thermal shrinkage rates in MD and in TD higher than those of the substrate film even after lamination. Accordingly, it is considered that when the laminate is subjected to drawing, by the heat, the PCTFE film shrinks more significantly than the substrate film, thus leading to curling.

Since the film of the present invention has small differences in the thermal shrinkage rates from the substrate film, the laminate is less likely to curl when subjected to drawing.

### [Process for Producing Film]

In the process for producing a film of the present invention, a resin material containing PCTFE is melted and extruded into a film from an extrusion die, and the extruded product is brought into contact with at least one casting roll to form a film (forming step).

Hereinafter, a casting roll with which the extruded product from the extrusion die is brought into contact i-th time (i is an integer of at least 1) will sometimes be referred to as “i-th casting roll”. For example, the casting roll with which the extruded product from the extrusion die is brought into contact first time will sometimes be referred to as the first casting roll.

In the forming step, before the extruded product is brought into contact with the first casting roll, the surface temperature of the extruded product is adjusted to be less than 170° C. Accordingly, when the extruded product is brought into contact with the first casting roll, its surface temperature (hereinafter sometimes referred to as “T₁”) is less than 170° C.

The extruded product is conveyed in an atmosphere and is not brought into contact with a solid (e.g. the roll) before brought into contact with the first casting roll.

### (Resin Material)

PCTFE is as described above.

The resin material may further contain, within a range not to impair the effects of the present invention, as the case requires, e.g. additives. The additives are as described above.

The proportion of PCTFE to the total mass of the resin material is preferably from 99 to 100 mass %, more preferably from 99.5 to 100 mass %, particularly preferably from 99.7 to 100 mass %. When the proportion of PCTFE is at least the above lower limit value, the resulting film will be more excellent in water vapor barrier property.

### (Forming Step)

An example of the forming step will be described with reference to FIG. 1.

FIG. 1 is a view schematically illustrating an example of an apparatus 10 for producing a film.

The production apparatus 10 comprises an extruder (not shown), an extrusion die 11 attached to the extruder, a first casting roll 12, a subsequently disposed second casting roll 13, a subsequently disposed pair of nip rolls 14, and an air knife 15.

The first casting roll 12 and the second casting roll 13 are disposed in series so that an extruded product 1 (molten resin material) extruded from the extrusion die 11 sequentially passes through the first casting roll 12 and the second casting roll 13 toward the pair of nip rolls 14.

The air knife 15 is disposed between the extrusion die 11 and the first casting roll 12.

As the extruder, a known extruder such as a single screw extruder or a twin screw extruder may be used.

As the extrusion die 11, a known extrusion die such as a T die (flat die) may be used.

As the first casting roll 12 and the second casting roll 13, ones capable of controlling the surface temperature may be used, and known casting rolls can be used.

An example in which the production apparatus 10 comprises two casting rolls 12 and 13 is shown, however, the number of the casting rolls which the production apparatus 10 has is not limited to two, and may be one or may be three or more.

The production apparatus 10 may further has a wind-up roll subsequent to the pair of nip rolls 14.

A pushing roll may be disposed so as to face the first casting roll so that the pushing roll can press the extruded product to the first casting roll when the extruded product and the first casting roll are brought into contact with each other.

In the production apparatus 10, the film is formed as follows.

The resin material containing PCTFE is melted by the extruder (not shown), and the resulting resin material melt is supplied to the extrusion die 11 and extruded into a film from the extrusion die 11. Then, the extruded product 1 extruded from the extrusion die 11 is conveyed so that it is sequentially brought into contact with the first casting roll 12 and the second casting roll 13 and passes between the pair of nip rolls 14. As the case requires, before the extruded product 1 is brought into contact with the first casting roll 12, an air in a laminar flow is made to blow on the extruded product 1 by the air knife 15.

The extruded product 1 is cooled by being brought into contact with the casting rolls 12 and 13 and its film shape is fixed, whereby a continuous film 2 is obtained. The extruded product 1 is typically conveyed so that one surface and the other surface of the extruded product 1 are alternately in contact with the plurality of the casting rolls 12 and 13.

As the case requires, the film 2 may be wound on a wind-up roll and formed into a roll, or the film 2 may be cut into sheets.

The temperature in the extruder (the temperature at which the resin material is melted) and the temperature of the extrusion die 11 are temperatures at which PCTFE is melted. The temperatures are typically the melting temperature of PCTFE or higher, respectively, and are preferably the melting temperature of PCTFE+(40° C. to 130° C.).

When the temperature in the extruder and the temperature of the extrusion die 11 are at least the above lower limit value, the melt can stably be extruded, and when they are at most the above upper limit value, deterioration of the material accompanying heat decomposition can be suppressed.

The surface temperature (hereinafter sometimes referred to as “To”) of the first casting roll 12 is preferably less than 170° C., more preferably less than 160° C., particularly preferably less than 150° C. When Tᵣ₁ is less than the above upper limit value, the productivity will be more excellent.

Tᵣ₁ is preferably at least 50° C., particularly preferably at least 80° C. When Tᵣ₁ is at least the above lower limit value, the film will be more excellent in flatness.

The surface temperature (hereinafter sometimes referred to as “Tᵣ₂”) of the second casting roll 13 is preferably at most Tᵣ₁, more preferably less than Tᵣ₁, particularly preferably at most (Tᵣ₁-20° C.).

The lower limit of Tᵣ₂ is, for example, 20° C.

Before the extruded product 1 is brought into contact with the first casting roll 12, the surface temperature T₁ of the extruded product 1 is adjusted to be less than 170° C., preferably less than 150° C., particularly preferably less than 130° C. Before the extruded product 1 is brought into contact with the first casting roll 12, the surface temperature of the extruded product 1 is gradually decreased by air cooling. When T₁ is at least 170° C., the surface temperature of the extruded product 1 may sometimes be higher than the crystallization temperature of the resin, and the extruded product 1 is quenched when brought into contact with the first casting roll 12. On that occasion, significant thermal strain will remain in the film, thus increasing the thermal shrinkage rates. When T₁ is less than 170° C., the surface temperature of the extruded product 1 will be sufficiently lower than the crystallization temperature of the resin when brought into contact with the first casting roll 12, the cooling rate will be gradual, and the thermal shrinkage rates are low. Further, since the cooling rate is gradual, the degree of crystallization of the film 2 tends to be high, and WVTR tends to be low.

T₁ is preferably at least 80° C., more preferably at least 90° C., particularly preferably at least 100° C. When T₁ is at least the above lower limit value, the film tends to be flat.

T₁ may be adjusted, for example, by at least one of the following conditions 1 to 3 in combination.

Condition 1: the flow rate of air made to blow on the extruded product 1 by the air knife 15.

Condition 2: the distance from the outlet A of the extrusion die 11 to the contact point C where the extruded product 1 and the first casting roll 12 are in contact with each other for the first time (hereinafter sometimes referred to as “A-C distance”).

Condition 3: the forming rate (extruded product 1 conveying rate).

By making air in a laminar flow blow on the extruded product 1 by the air knife 15, the cooling rate of the extruded product 1 before contact with the first casting roll 12 will be high, whereby the desired T₁ can be achieved even if the A-C distance is short, and the productivity of the film 2 can be improved. Further, when the cooling rate is high, the degree of crystallization of the film 2 will be low and as a result, the haze tends to be low, WVTR tends to be high, and the tensile elongations tend to be large.

In a case where air is made to blow on the extruded product 1, the air flow rate is preferably from 0.5 to 30 m/sec, particularly preferably from 1 to 20 m/sec. When the air flow rate is at least the above lower limit value, the productivity of the film 2 will be more excellent, and the haze of the film 2 can be made lower and the tensile elongations larger. When the air flow rate is at most the above upper limit value, WVTR of the film 2 can be made lower.

The air temperature is, for example, from 0 to 120° C., preferably from 15 to 100° C.

The distance between the outlet A of the extrusion die 11 to the center of the air knife 15 is preferably from 5 to 200 mm, particularly preferably from 10 to 125 mm. When the distance is at least the above lower limit value, installation of the air knife 15 tends to be easy. When the distance is at most the above upper limit value, the extruded product 1 can effectively be cooled.

The A-C distance is set depending upon the desired T₁. The longer the A-C distance is, the lower T₁ is. The A-C distance is preferably from 80 to 1,000 mm, particularly preferably from 100 to 500 mm.

In a case where the air is not made to blow on the extruded product 1, the A-C distance is preferably from 100 to 1,000 mm, particularly preferably from 150 to 500 mm. When the A-C distance is at least the above lower limit value, T₁ is easily made to be less than 170° C. When the A-C distance is at most the above upper limit value, the productivity of the film 2 will be more excellent.

In a case where the air is made to blow on the extruded product 1, the A-C distance is preferably from 80 to 500 mm, particularly preferably from 100 to 400 mm. When the A-C distance is at least the above lower limit value, T₁ is easily made to be less than 170° C. When the A-C distance is at most the above upper limit value, the productivity of the film 2 will be more excellent.

The temperature in the atmosphere from the outlet A of the extrusion die 11 to the contact point C where the extruded product 1 and the first casting roll 12 are in contact with each other for the first time is, for example, from 10 to 50° C.

The film forming rate is preferably from 1 to 50 m/min, particularly preferably from 2 to 40 m/min. When the forming rate is at least the above lower limit value, the productivity of the film will be good. When the forming rate is at most the above upper limit value, T₁ of the extruded product 1 is easily adjusted to be less than 170° C.

After the forming step, the obtained film may further be subjected to post-processing to obtain a final product.

As the post-processing, cutting of the film, an orientation treatment, a surface treatment, printing or coating may, for example, be mentioned.

If orientation treatment is conducted, the thermal shrinkage rates of the film tend to be high, and the tensile elongations in MD and in TD tend to be small, and accordingly it is preferred not to conduct the orientation treatment. In a case where the orientation treatment is conducted, the orientation treatment conditions are preferably such that the thermal shrinkage rates of the film in MD and in TD after the orientation treatment will not exceed +1.2% or be less than −1.2%.

In the above described process for producing a film of the present invention, the resin material containing PCTFE is melted and extruded into a film from the extrusion die, and the surface temperature of the extruded product is adjusted to be less than 170° C. before the extruded product is brought into contact with at least one casting roll, whereby a film having low thermal shrinkage rates can be produced.

### [Laminate]

The laminate of the present invention is a laminate of a layer consisting of the film of the present invention and at least one other layer.

The laminate of the present invention may have one or more layers consisting of the film of the present invention and one or more other layers. The total number of layers constituting the laminate of the present invention is, for example, from 2 to 5.

FIG. 2 is a cross sectional view schematically illustrating an example of the laminate of the present invention.

A laminate 40 shown in FIG. 2 is a laminate having a layer 41 consisting of the film of the present invention, an adhesive layer 45 (other layer) and a substrate layer 43 (other layer) present in this order.

The material constituting the substrate layer 43 may, for example, be polypropylene, polyvinyl chloride, polyvinylidene chloride, a cyclic olefin polymer or a non-oriented polyethylene terephthalate.

The thickness of the substrate layer 43 is, for example, from 100 to 1,000 μm.

The adhesive constituting the adhesive layer 45 may, for example, be a urethane adhesive or a polyester adhesive.

The thickness of the adhesive layer 45 is, for example, from 1 to 10 μm.

The laminate 40 may be produced, for example, by bonding a layer consisting of the film of the present invention and the substrate layer 43 by the adhesive.

The thermal shrinkage rates of the substrate layer 43 before bonded to the film of the present invention in MD and in TD are, for example, within ±2.0%.

In order to improve the adhesion between the layer consisting of the film of the present invention and other layer, before other layer is laminated, the film of the present invention or the substrate layer 43 may be subjected to surface treatment. The surface treatment may, for example, be plasma treatment, corona treatment or ultraviolet treatment.

To bond the film of the present invention and the substrate layer 43, known lamination method such as dry lamination or wet lamination may be employed.

The above-described laminate of the present invention, which comprises the film of the present invention, is less likely to curl when subjected to drawing.

Further, since the film of the present invention has water vapor barrier property, the laminate of the present invention also has water vapor barrier property.

### [Packaging Material]

The packaging material of the present invention comprises the film of the present invention or the laminate of the present invention.

The packaging material of the present invention is preferably a packaging material for blister packaging.

FIG. 3 is a cross sectional view schematically illustrating an example of a package in which a content is accommodated in blister packaging. FIG. 3 illustrates a state where a content is accommodated in the package. The content may, for example, be a chemical capsule.

A package 50 shown in FIG. 3 comprises a container 51 and a cover 53.

The container 51 has at least one pocket portion 51a. The pocket portion 51a has a concave portion which opens toward one side of the container 51. A content 60 is to be accommodated in the concave portion. The pocket portion 51a is formed to protrude toward the other side of the container 51.

The cover 53 is laminated on one side of the container 51 and seals the opening of the concave portion of the pocket portion 51a.

By subjecting the packaging material of the present invention, for example, the above laminate 40, is subjected to drawing by a known method to form the pocket portion 51a, the container 51 is obtained. In a case where the pocket portion 51a is formed on the laminate 40, usually, the pocket portion 51a is formed so that the layer 41 consisting of the film of the present invention faces the inside (the cover 53 side).

As the cover 53, one known as a cover material for blister packaging may be used. For example, a cover comprising a substrate consisting of e.g. an aluminum foil, and a heat seal layer laminated on one side (container 51 side) of the substrate may be used.

### EXAMPLES

Now, the present invention will be described in further detail with reference to Examples. However, it should be understood that the present invention is by no means restricted to the following description.

Among the after-described Ex. 1 to 6, Ex. 1 to 3 and 6 are Examples of the present invention, and Ex. 4 and 5 are Comparative Examples.

Measurement and evaluation methods in Ex. and materials are shown below.

### (Measurement Method)

### <MVR>

MVR (mm³/sec) of PCTFE was measured in accordance with the method specified in JIS K7210-1:2014 (corresponding international standard ISO 1133-1:2011), under conditions at a temperature of 230° C. under a pressure of 100 kg/cm² at L/D=1/1 mm.

### <Melting Point, Crystallization Temperature>

The melting point of PCTFE was measured by a differential scanning calorimeter (manufactured by Seiko Instruments Inc., DSC7020) at a heating rate of 10° C./min.

The crystallization temperature of PCTFE was defined by the position of an exothermic peak measured by a differential scanning calorimeter (manufacture by Seiko Instruments Inc., DSC7020) at a cooling rate of 10° C./min with respect to once molten PCTFE.

Specifically, in an aluminum pan, 10±0.2 mg of a sample was weighed, and the aluminum pan was tightly stopped with an aluminum cap. 10±0.2 mg of alumina as a comparative material was weighed in the same manner, and the aluminum pan was tightly stopped with an aluminum cap. The sample and the comparative material were set to the differential scanning calorimeter, heated at 10° C./min from 30° C. to 270° C., held for 5 minutes and then cooled at a cooling rate of 10° C./min to 120° C. or lower. The temperature corresponding to the maximum value of the melting peak which appeared in the heating procedure in the obtained DSC curve was defined as the melting point. Further, the temperature corresponding to the aluminum pan exothermic peak temperature which appeared in the cooling procedure was defined as the crystallization temperature.

### <Surface Temperature of Extruded Product and Casting Roll>

The surface temperature of the extruded product was measured by an infrared radiation thermometer (manufactured by Sato Keiryo Mfg. Co., Ltd., SK-8900) at an emissivity of 0.85 at an angle of 30° to the surface of the extruded product at a position about 20 cm apart from the surface. In the present invention, the surface temperature of the extruded product is a measured value at the center in the film width direction. The surface temperature of the casting roll was measured by a contact type surface thermometer (manufactured by Anritsu Meter Co., Ltd., HA-200E).

### <Thickness>

The thickness of the film was measured by a contact type thickness meter (micrometer manufactured by Mitutoyo Corporation).

### <WVTR>

The water vapor transmission rate (WVTR) of the film was measured in accordance with the method specified in JIS K7129:2008 Appendix B at 37.8° C. under 100% RH, using a water vapor transmission rate measuring apparatus (manufactured by MOCON Inc., PERMATRAN-W3/31).

### <Haze>

The haze of the film was measured by a haze meter (manufactured by NIPPON DENSHOKU INDUSTRIES CO., LTD., NDH-5000) in accordance with the method specified in JIS K7136:2000 (corresponding international standard: ISO 14782:1999) using CIE standard colorimetric illuminant D65 in accordance with JIS Z8781-2:2012 (corresponding international standard ISO 11664-2:2007) at 23° C.

### <Tensile Elongation>

The tensile elongations of the film were measured in accordance with ASTM D638 with respect to an ASTM V dumbbell test specimen at a pulling rate of 200 mm/min at 23° C.

### <Thermal Shrinkage Rate>

The thermal shrinkage rates of the film were obtained by the following method with respect to a sample obtained by cutting the film into a length (MD) of 12 cm and a width (TD) of 12 cm.

At 25° C., one straight line of about 10 cm in length was drawn on the sample in directions along MD and TD respectively, and the distance between the end points of each straight line was taken as the initial length L₀. Then, the sample was subjected to heat treatment at 140° C. for 30 minutes and cooled to 25° C., and the linear distance L₁ between the end points of the straight line drawn on the sample was measured, and the thermal shrinkage rate (%) was obtained in accordance with the following formula 3.

Thermal shrinkage rate (%)=(1−L₁/L₀)×100 Formula 3

The thermal shrinkage rate obtained with respect to the straight line along MD was taken as the thermal shrinkage rate in MD, and the thermal shrinkage rate obtained with respect to the straight line along TD was taken as the thermal shrinkage rate in TD.

### Production Example 1: Preparation of PCTFE

A stainless steel polymerization vessel having an internal capacity of 2.5 L was evacuated of air, 1,000 g of deionized water as a solvent, 4.0 g of potassium persulfate as an initiator and 555 g of chlorotrifluoroethylene (CTFE) were charged, and the internal temperature was adjusted to 50° C. The pressure on that time was 1.17 MPaG. “G” in “MPaG” means the gage pressure.

Then, an aqueous sodium bisulfite solution (8.6 g of sodium bisulfite in 100 g of deionized water) was added to initiate the polymerization. Addition was conducted at a rate of 7.4 cc/hr over a period of 4 hours, 7 hours after initiation of addition, the mixture was cooled, unreacted CTFE was purged, and the polymer was taken out from the polymerization vessel, washed and dried to obtain 105 g of PCTFE.

MVR of the obtained PCTFE was 75 mm³/sec, the melting point was 211° C., and the crystallization temperature was 186° C.

Using a production apparatus having the same structure as that of the production apparatus 10 shown in FIG. 1, a film web was formed in the following procedure. As the extruder, a single screw extruder having a barrel diameter of 30 mm was used. As the extrusion die 11, a die for a film having an opening width of 250 mm was used. The distance from the outlet of the extrusion die 11 to the center of the air knife 15 was 25 mm.

### Ex. 1

PCTFE in Production Example 1 was melted by the extruder and extruded from the extrusion die 11 to form an extruded product in the form of a film, which was made to sequentially pass through the first casting roll 12, the second casting roll 13 and the nip rolls 14 to fix the film shape, thereby to form a film having a thickness of 100 μm. The temperature of the extrusion die 11 was 300° C., the distance from the outlet of the extrusion die 11 to the first casting roll 12 (A-C distance) was 215 mm, the surface temperature Tᵣ₁ of the first casting roll 12 was 90° C., the surface temperature of the second casting roll 13 was 60° C., and the forming rate was 1.1 m/min. The air knife 15 was not used. The surface temperature of the extruded product 1 at a position 10 mm upstream the contact point C where the extruded product 1 and the first casting roll 12 were in contact with each other for the first time was measured, and the temperature was taken as the surface temperature T₁ of the extruded product when brought into contact with the first casting roll 12. The physical properties of the obtained film (the water vapor transmission rate, the haze, the tensile elongations and the thermal shrinkage rates) of the obtained film are shown in Table 1.

### Ex. 2 and 3

A film having a thickness of 100 μm was obtained in the same manner as in Ex. 1 except that the air knife was used, and air in a laminar flow was made to blow on the extruded product entirely in the width direction under the conditions as identified in Table 1 to increase the cooling rate of the extruded product. The physical properties (the water vapor transmission rate, the haze, the tensile elongations and the thermal shrinkage rates) of the obtained film are shown in Table 1. The air temperature in Ex. 2 and 3 was 41±3° C.

### Ex. 4 to 6

A film having a thickness of 100 μm was formed in the same manner as in Ex. 1 except that the air knife was removed from the production apparatus, and the A-C distance was 80 mm, 150 mm or 155 mm. The physical properties of the obtained film are shown in Table 1.

TABLE 1

| | | | | | | | Film physical properties | | | |
|---|---|---|---|---|---|---|---|---|---|---|
| | | | | | | | | | | Thermal |
| | | Air knife | | | | | | | Tensile | shrinkage |
| | A-C | Flow | | | | | | | elongations | rates |
| | distance | amount | Flow rate | Temperature | T₁ | Tᵣ₁ | WVTR | Haze | (MD/TD) | (MD/TD) |
| | mm | L/min | m/sec | ° C. | ° C. | ° C. | g/(m² · day) | % | % | % |
| Ex. 1 | 215 | 0 | 0 | — | 134 | 90 | 0.036 | 23 | 67/110 | 0.1/0.1 |
| Ex. 2 | 215 | 100 | 7.4 | 41 ± 3 | 81 | 90 | 0.057 | 5.5 | 127/149 | 0.2/−0.1 |
| Ex. 3 | 215 | 50 | 3.7 | 41 ± 3 | 93 | 90 | 0.044 | 10.7 | 100/160 | 0.2/−0.2 |
| Ex. 4 | 80 | 0 | 0 | — | 230 | 90 | 0.074 | 0.35 | 202/240 | 3.9/−2.3 |
| Ex. 5 | 150 | 0 | 0 | — | 178 | 90 | 0.071 | 1.6 | 190/198 | 1.5/−1.1 |
| Ex. 6 | 155 | 0 | 0 | — | 166 | 90 | 0.041 | 19 | 132/165 | 0.5/0.2 |

The following was confirmed from the results shown in Table 1.

By adjusting the surface temperature of the extruded product to be less than 170° C. before brought into contact with the first casting roll, a film having low thermal shrinkage rates can be obtained. This film has sufficiently large tensile elongations and is less likely to be broken when subjected to drawing. Further, the film has low WVTR and is excellent in water vapor barrier property.

### INDUSTRIAL APPLICABILITY

When the film of the present invention, which has thermal shrinkage rates in MD and in TD of so low as within ±1.2%, is laminated with other layer and the resulting laminate is subjected to drawing, the laminate is less likely to curl. Accordingly, the laminate of the present invention is suitable as a material for constituting the laminate. However, the film of the present invention is not limited to a laminate and may be used alone.

The application of the film of the present invention and the laminate of the present invention is not limited, and they may be used, for example, for a packaging material, a flexible solar cell surface material, a surface material of a display device using organic EL, etc.

This application is a continuation of PCT Application No. PCT/JP2019/031974, filed on Aug. 14, 2019, which is based upon and claims the benefit of priority from Japanese Patent Application No. 2018-157182 filed on Aug. 24, 2018. The contents of those applications are incorporated herein by reference in their entireties.

### REFERENCE SYMBOLS

1: extruded product, 2: film, 10: apparatus for producing film, 11: extrusion die, 12: first casting roll, 13: second casting roll, 14: nip roll, 15: air knife, 40: laminate, 41 layer consisting of film of the present invention, 43: substrate layer, 45: adhesive layer, 50: package, 51: container, 51a: pocket portion, 53: cover, 60: content.

What is claimed is:

1. A film comprising polychlorotrifluoroethylene,
having thermal shrinkage rates within ±1.2% in MD and in TD when heated at 140° C. for 30 minutes and then cooled to 25° C., based on the dimension at 25° C.

2. The film according to claim 1, which has a haze per thickness 100 μm of from 3 to 20%.

3. The film according to claim 1, which has a water vapor transmission rate of at most 0.07 g/(m²·day) per thickness 100 μm at 37.8° C. under a relative humidity of 100%.

4. The film according to claim 1, which has tensile elongations in MD and in TD at 23° C. of respectively at least 30%.

5. A process for producing a film, which comprise melting a resin material containing polychlorotrifluoroethylene and extruding it into a film from an extrusion die, and bringing the extruded product into contact with at least one casting roll to form a film,
wherein before the extruded product is brought into contact with the at least one casting roll, the surface temperature of the extruded product is adjusted to be less than 170° C.

6. The process for producing a film according to claim 5, wherein before the extruded product is brought into contact with the at least one casting roll, air in a laminar follow is made to blow on the extruded product by an air knife.

7. The process for producing a film according to claim 5, wherein the distance from the outlet of the extrusion die to the contact point where the extruded product is brought into contact with the at least one casting roll for the first time, is from 80 to 1,000 mm.

8. The process for producing a film according to claim 6, wherein the distance from the outlet of the extrusion die to the contact point where the extruded product is brought into contact with the at least one casting roll for the first time, is from 80 to 500 mm.

9. The process for producing a film according to claim 5, wherein the film forming rate is from 1 to 50 m/m in.

10. A laminate comprising a layer consisting of the film as defined in claim 1, and at least one other layer.

11. A packaging material comprising the film as defined in claim 1.

12. The packaging material according to claim 11, for blister packaging.
